(19) United States
(12) Patent Application Publication
(10) Pub. No.: US 2004/0153442 A1
(43) Pub. Date: Aug. 5, 2004

(54) Method and apparatus to generate a controlled copy of information stored on an optical storage media

(76) Inventors: Brian D. Mantz, Austin, TX (US); James E. Roberts, Las Vegas, NV (US); Uma M. Veeramani, Austin, TX (US)

Correspondence Address: MICHAEL A. DAVIS, JR., HAYNES and BOONE, LLP., 901 MAIN STREET, SUITE 3100, DALLAS, TX, 75202-3789, US

(21) Appl. No.: 10/358,054

(22) Filed: Feb. 4, 2003

(51) Int. Cl. G06F 7/00

(52) U.S. Cl. 707/3

(57) ABSTRACT

A method and apparatus to generate a controlled copy of information stored on an optical storage media. The method and apparatus comprising reading accessible information from a source optical storage media, generating information corresponding to inaccessible information stored on the source optical storage media; and saving the accessible information and the generated information such that the generated information is accessible. The accessible information and the generated information may be written to a first optical storage media. Also, the method and apparatus may modify the information saved on the persistent data storage media to either violate or not violate optical media standards, and write the modified information to a second optical storage media.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND

1. Field of the Invention

The invention is related to the field of storage media protection. In particular, the invention is related to a method and apparatus to generate a controlled copy of information stored on an optical storage media.

2. Description of the Related Art

Optical storage media e.g., compact discs (CDs), Compact Disc-recordable (CD-R), Compact Disc-Read Only Memory (CD-ROM), Compact Disc-Programmable/Hybrid CD etc. store information e.g., audio, text, and graphics information that may be valuable. Therefore, the information stored on the optical storage media may be copy protected to protect against piracy (i.e., the unauthorized copying of the information). Various forms of piracy protections exist to protect the information stored on optical storage media, e.g., storing a key or bit pattern (copy protection) in at least the first logical lead-in area, the user data area, the last logical lead-out area, or the channel information area of the CD. The channel information area comprises channel information in the first logical lead-in area, the channel information in the first logical lead-out area and the channel information in the user-data area. (For more information on the first logical lead-in area, last logical lead-out, user data area, and channel area of a CD-ROM please see European Computer Manufactures Association (ECMA) standards119 and 130). Thereafter, the copy protection is authenticated prior to accessing the information stored on the CD. However, when an unauthorized copy of the CD is made the copy protection or the protected information is not transferred to the unauthorized copy thereby indicating that the copied CD is an unauthorized copy.

Due to the variances of optical drives in reading and/or writing information to optical storage media, and due to the industry-wide restrictions placed on the optical drives, once data is written to an optical storage media, the optical drive hardware and software is unable to retrieve and/or display a bit by bit representation of data stored on the optical storage media. In particular, the drive hardware and software is unable to retrieve and/or display information in at least the first logical lead-in and the last logical lead-out areas (restricted areas) of the optical storage media. This makes generating and writing e.g., copy protection to optical storage media inefficient since variances in the restricted areas may affect the operation and/or functionality of the copy protection, and a bit by bit representation of the data that includes the copy protection is unavailable to diagnose potential problems. In addition, existing methods to generate copy protections for optical storage media are time consuming, as generating new copy protections comprise a modification of the copy protection program code. Furthermore, for the reasons stated above, optical drive manufacturers cannot easily diagnose and correct read or write problems with the optical storage drives as problems with optical storage media (necessary to test optical drives) cannot be created in a predictable manner.

### BRIEF SUMMARY OF THE DRAWINGS

Example embodiments of the invention are illustrated in the accompanying drawings. The accompanying drawings, however, are not intended to limit the scope of the invention. Similar references in the drawings indicate similar elements.

FIG. 1 illustrates a block diagram of a software module to generate a controlled copy of information of a source optical storage media according to one embodiment of the invention.

FIG. 2 illustrates a flow diagram for generating a controlled copy of information of a source optical storage media according to one embodiment of the invention.

FIG. 3 illustrates a block diagram of a user interface for generating a controlled copy of information of a source optical storage media according to one embodiment of the invention.

FIG. 4 illustrates a block diagram of an apparatus for generating a controlled copy of information of a source optical storage media according to one embodiment of the invention.

### DETAILED DESCRIPTION

Described is a method and apparatus to generate a controlled copy of information stored on a source optical storage media. The method and apparatus comprises reading accessible information from a source optical storage media, generating information corresponding to inaccessible information stored on the source optical storage media; and saving the accessible information and the generated information such that the generated information is accessible.

Reading accessible information from the source optical storage media comprises reading user data from the source optical storage media; determining whether channel information in a user data area is accessible on the source optical storage media, and reading the channel information if the channel information in the user data area is accessible.

Generating information corresponding to inaccessible information stored on the source optical storage media comprises generating information representative of the table of contents from the source optical storage media; determining whether channel information in a user data area is accessible on the source optical storage media, and generating the channel information of the user data area if the channel information in the user data area is not accessible. Furthermore, generating information corresponding to inaccessible information stored on the source optical storage media comprises generating channel information of a first logical lead-in area, generating channel information of a last logical lead-out area, generating information comprising a first logical lead-in area, and generating information comprising a last logical lead-out area. The accessible information and the generated information may be written to a first optical storage media. Also, the method and apparatus may modify the information saved such that the information saved violates optical media standards, and write the modified information to a second optical storage media.

In the following description numerous specific details are set forth in order to provide a thorough understanding of the present invention. It will be apparent, however, to one of ordinary skill in the art that the present invention may be practiced without these specific details. In other instances, well-known architectures, steps, and techniques have not been shown to avoid obscuring the present invention.

The invention may utilize a distributed computing environment. In a distributed computing environment, program modules may be physically located in different local and remote memory storage devices. For example, a database module comprising information in the first logical lead-in area, information in the last logical lead-out area, information in the channel area, the user data, and the table of content information may be disposed remotely to a module (e.g., the dissector module) that modifies the information read from the source optical media. Execution of the program modules may occur locally in a stand-alone manner on the same server, or evaluation of the program modules may occur remotely in a client/server manner. Examples of such distributed computing environments include local area networks, enterprise-wide computer networks, and the global Internet. Lastly, repeated usage of the phrase “in one embodiment” does not necessarily refer to the same embodiment, although it may.

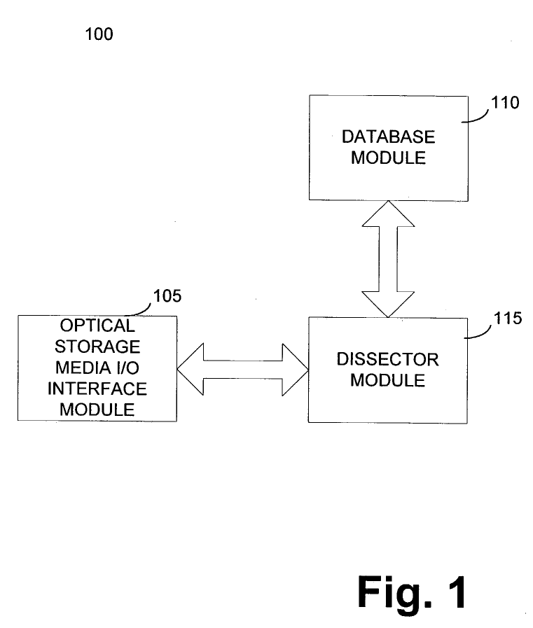

FIG. 1 illustrates a block diagram of a software module to generate a controlled copy of information of a source optical storage media according to one embodiment of the invention. As illustrated in FIG. 1, the software module 100 comprises an optical storage media input output (I/O) interface module 105, a database module 110, and a dissector module 115. Optical storage media I/O interface module 105 is communicatively coupled with dissector module 115 and transmits and receives information from/to dissector module 115. In one embodiment of the invention, the optical storage media I/O interface module 105 may receive a command from dissector module 115 to read or write information from or to an optical storage media. An optical storage media is a media that stores information that may be read or written to by a laser, and includes a compact disc (CD), a Compact Disc-recordable (CD-R), a Compact Disc-Read Only Memory (CD-ROM), Compact Disc-Programmable/Hybrid CD etc.

Dissector module 115 may use the information received from optical storage media I/O interface module 105 to generate the information comprising the first logical lead-in area, the last logical lead-out area, and if necessary, the channel information areas. Dissector module 115 is communicatively coupled with database module 110. In one embodiment of the invention, at least the information generated by dissector module 115 and the information that is read by optical storage media I/O interface module 105 is saved in database module 110. Database module 110 may store the information received from the dissector module 115 in one or more files, or a database e.g., a relational database, and provides all the functionality of a database e.g., sorting, searching etc., well known by one having ordinary skill in the art. In one embodiment of the invention, database module 110 is disposed in the memory of e.g., in temporary memory of a computer system. In one embodiment of the invention, database module 110 is disposed on a persistent data storage media such as a floppy disk, fixed disk (e.g., magnetic disk, optical disk, magneto-optical disk, or the like), or streaming tape. A persistent data storage media may be defined as media that retains stored information, and from which the stored information may be read without the need for a power source to retain the stored information. In one embodiment of the invention, if database module 110 is disposed on an optical media, the database module 110 is disposed on an accessible area of the optical media, i.e., an area on an optical media wherein a bit-by-bit representation of the information may be written, and thereafter read.

Information on an optical storage media is found in information sessions, and multiple information sessions are permitted within a single optical storage media. An information session comprises a part of an optical storage media. When multiple information sessions are present on an optical storage media, each information session has a logical lead-in and a logical lead-out area. Thus, a logical lead-out area of a first information session is contiguous with a logical lead-in area of the next information session and so on. Information in the logical lead-in and logical lead-out areas are accessible as part of the user data area on an optical storage media. However, the information in first logical lead-in area and last logical lead-out area of the optical storage media is not accessible. One having ordinary skill in the art will appreciate that a logical lead-in area is a physical lead-in area, and a logical lead-out area is a physical lead-out area on an optical storage media. Information recorded in information sessions is grouped into sectors, a sector being the smallest addressable part of the information that is addressed independently. The number of sectors of an information session is variable and depends upon the information recorded in the information session. A sector in an optical media e.g., a CD-ROM typically comprises 2352 8-bit bytes, and the sector layout depends upon the setting of the sector mode byte. Information sessions of an optical storage media are found in information tracks. Thus, information tracks are divided into sectors, and individual sectors, or a group of sectors identified by an information track may be addressable. Depending upon the setting of the sector mode byte, the user data is read from the appropriate location in the sector. Each sector has a unique address, and the address of the first sector with user data of an information session is stored in a table of contents of the optical media. However, since the table of contents of the optical media is in the first logical lead-in area, it is not directly accessible, and information representative of the table of contents has to be generated when copying information from an optical storage media.

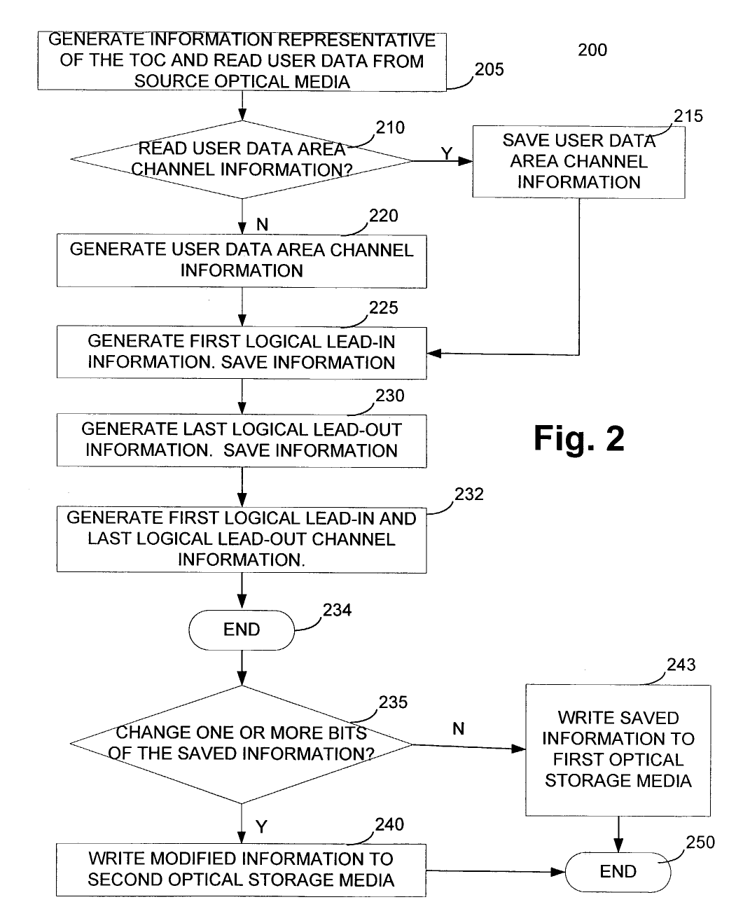

FIG. 2 illustrates a flow diagram for generating a controlled copy of information of a source optical storage media according to one embodiment of the invention. As illustrated in FIG. 2, in flow diagram 200 at 205, information representative of the table of contents is generated e.g., by dissector module 115 (since the table of contents is not directly accessible) from a source optical storage media. The user data from the source optical storage media is accessible and is read by e.g., optical storage media I/O interface module 105. In one embodiment of the invention, the source optical storage media is the optical storage media that comprises information that is to be copied or modified (e.g., to protect the information stored thereon).

After generating the information representative of the table of contents and reading the user data from the source optical storage media, the information representative of the table of contents and the user data is saved e.g., on a database in database module 110. Generating the information representative of the table of contents is well known by one having ordinary skill in the art. In one embodiment of the invention, the information read from the optical media is read using any commercially available optical media drive.

At 210, a determination is made by e.g., dissector module 115 whether channel information in the user data area of the optical media is accessible. If the channel information in the user data area is accessible, at 215, the channel information in the user data area is saved to the database module 110. If the channel information in the user data area is not accessible at 220, the channel information of the user data area is generated by, e.g., dissector module 115 and saved in database module 110. At 225, the information comprising the first logical lead-in area (other than the table of contents, since the table of contents has already been generated) for the optical storage media is generated and saved in the database module 110. At 230, the information comprising the last logical lead-out area for the optical storage media is generated and saved in the database module 110. At 232, channel information of the first logical lead-in area and channel information of the last logical lead-out area is generated and saved in the database module 110. The generation of the information comprising the first logical lead-in area, the last logical lead-out area and the generation of channel information is well known by one having ordinary skill in the art and is not discussed herein. Thus, the information comprising the first logical lead-in area, the information comprising the last logical lead-out area, the information comprising the channel areas and the user data may be saved in tables in the database module 110. In an alternate embodiment of the invention, this information may be saved in database module 110 when the information is written to a subsequent optical storage media. After saving the information read and generated from the source optical storage media the process may end at 234. Each binary bit of information saved in the tables of database module 110 may be accessed and/or modified by dissector module 115. In one embodiment of the invention, the saved information may be modified, and the modified information written to a subsequent optical storage media with or without regard to violations of optical media standards e.g., the ECMA standards.

Thus, if at 235 one or more bits of at least the information comprising the first logical lead-in area, the information comprising the last logical lead-out area, the information comprising the channel area and the user data is not modified, at 243, the information generated and read from the source optical media may be written to a first optical storage media. Thus, the first optical storage media, and in particular the information stored in database module 110, functions as a primary information source from which copies of the information stored on the first optical storage media may be generated and written to subsequent optical storage media. If at 235, the information comprising the first logical lead-in area, the information comprising the last logical lead-out area, the information comprising the channel area and the user data is modified, at 240 the modified information may be written to a second optical storage media. Thus, after writing information to the first and/or the second optical storage media, the process ends at 250. Having a copy of the information that is on the first optical storage media saved in the database module 110, overcomes the inability to access the information stored in inaccessible areas on the source optical storage media.

In one embodiment of the invention, when a copy protection is written e.g., in the first logical lead-in area, and/or in the last logical lead-out area of an optical storage media, the functionality of the copy protection can be easily verified. In one embodiment of the invention, the copy protection is verified by writing a particular bit pattern to normally inaccessible areas of the optical storage media and reading the particular bit pattern using a variety of drives. If changes are needed to the copy protection on the optical storage media, the information stored in the database module 110 corresponding to the optical storage media is easily retrieved and modified by dissector module 115. For each modification made to the copy protection, a record of the change is stored in database module 110 enabling the functionality of the copy protection and the functionality of the copy protected information on the optical storage media to be easily checked. Since the information written to subsequent optical storage media is retained or saved in database module 110 the process of generating variations of the stored information or generating multiple copies of a particular optical storage media is easily accomplished.

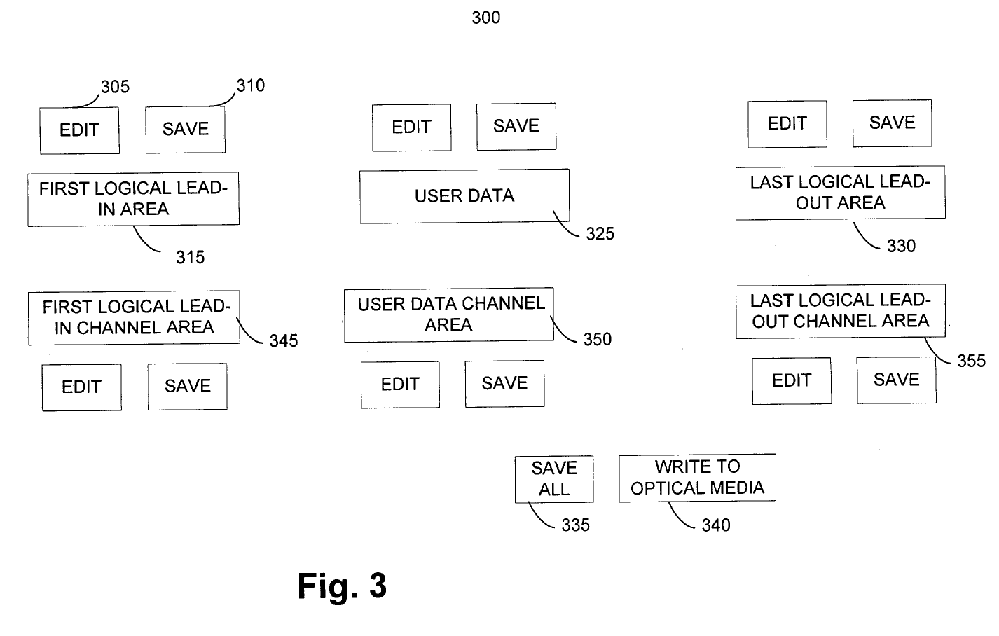

FIG. 3 illustrates a block diagram of a user interface for generating a controlled copy of information of a source optical storage media according to one embodiment of the invention. As FIG. 3 illustrates, user interface 300 comprises a first display area 325 for displaying user data for an optical media. In addition, the user interface 300 may have at least one of a second display area 315 for displaying information comprising the first logical lead-in area, a third display area 330 for displaying information comprising the last logical lead-out area, a fourth display area 345 for displaying channel information in the first logical lead-in channel area, a fifth display area 350 for displaying channel information in the user data area, and a sixth display area 355 for displaying channel information in the last logical lead-out channel area for the optical storage media. The user interface 300 may have an executable process to modify at least one of the information comprising the first logical lead-in area, the information comprising the last logical lead-out area, the information in the channel area, and the user data. In one embodiment of the invention, selecting edit button 305 enables modifying of information comprising the first logical lead-in area. So also, selecting edit buttons corresponding to the user data, the last logical lead-out area, and the corresponding channel area enables modifying of information contained in the corresponding areas. In one embodiment of the invention, merely clicking a cursor in the displayed area enables modifying of the information contained in that area. In one embodiment of the invention, selecting save button 310 saves the information comprising the lead-in area to database module 110. So also, selecting save buttons corresponding to the user data, last logical lead-out area, and the channel area enables the saving of information contained in the corresponding areas to database module 110. In one embodiment of the invention user interface 300 comprises a save all button 335 for saving all the information corresponding to the areas displayed in the user interface to database module 110. In one embodiment of the invention, the user interface 300 has a write to optical storage media button 340 for writing the information corresponding to the displayed fields in the user interface 300 to an optical storage media.

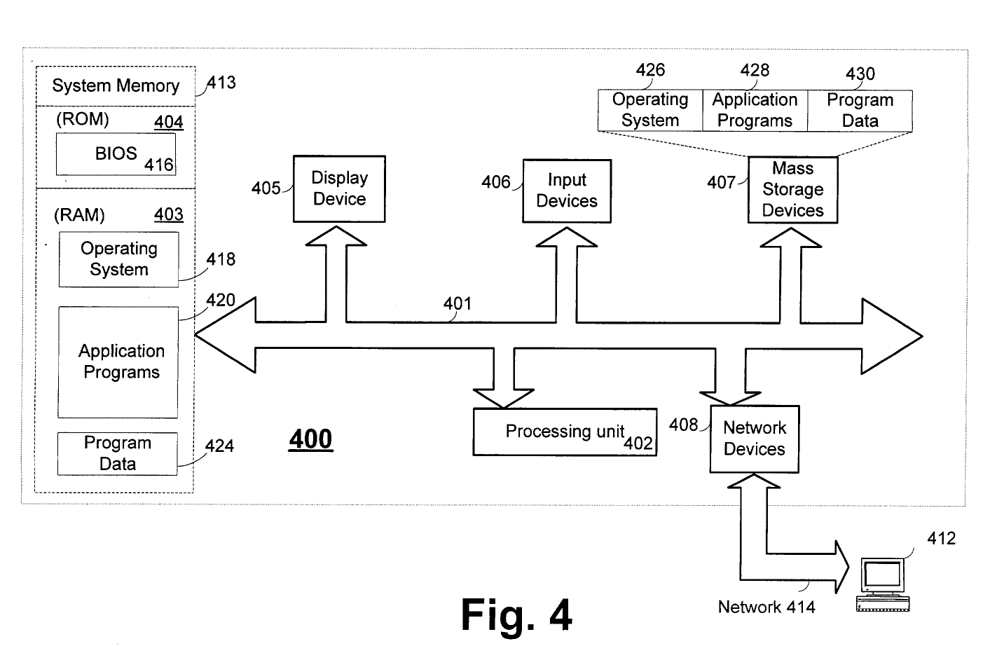

FIG. 4 illustrates a block diagram of an apparatus for generating a controlled copy of information of a source optical storage media according to one embodiment of the invention. As illustrated in FIG. 4, the apparatus may include a computer system 400, and may comprise a processing unit 402 communicatively coupled through a bus 401 to system memory 413, mass storage devices 407, Input devices 406, display device 405 and network devices 408.

Bus 401 may be any of several types of bus structures including a memory bus, a peripheral bus, and a local bus using any of a variety of bus architectures. System memory 413 comprises a read only memory (ROM) 404 and random access memory (RAM) 403. In one embodiment of the invention, RAM 403 comprises temporary memory of the computer system 400. ROM 404 comprises basic input output system (BIOS) 416. BIOS 416 contain the basic routines, e.g., start up routines, that facilitate the transfer of information between elements within computer system 400. RAM 403 includes cache memory and comprises operating system 418, application programs 420, and program data 424. Application programs 420 include the program code for implementing the method described with reference to FIGS. 1-3. Program data 424 may include data generated by application programs 420. Mass storage device 407 represents a persistent data storage device, such as a floppy disk drive, fixed disk drive (e.g., magnetic, optical, magneto-optical, or the like), or streaming tape drive. Mass storage device 407 may store application programs 428, operating system 426 for computer system 400, and program data 430. Application programs 428 and program data 430 stored on mass storage devices 407 may include the application programs 420 and program data 424 stored in RAM 403. One embodiment of the invention may be stored entirely as a software product on mass storage device 407. Embodiments of the invention may be represented as a software product stored on a machine-readable medium (also referred to as a computer-accessible medium, a machine-accessible medium, or a processor-accessible medium). The machine-readable medium may be any type of magnetic, optical, or electrical storage medium including a diskette, CD-ROM, memory device (volatile or non-volatile), or similar storage mechanism. The machine-readable medium may contain various sets of instructions, code sequences, configuration information, or other data. Those of ordinary skill in the art will appreciate that other instructions and operations necessary to implement the described invention may also be stored on the machine-readable medium. One embodiment of the invention may be embedded in a hardware product, for example, in a printed circuit board, in a special purpose processor, or in a specifically programmed logic device communicatively coupled to bus 401. Processing unit 402 may be any of a wide variety of general-purpose processors or microprocessors (such as the Pentium® processor family manufactured by Intel° Corporation), a special purpose processor, or a specifically programmed logic device. Processing unit 402 is operable to receive instructions which, when executed by the processing unit cause the processing unit to execute application programs 420.

Display device 405 is coupled to processing unit 402 through bus 401 and provides graphical output for computer system 400. Input devices 406 such as a keyboard or mouse are coupled to bus 401 for communicating information and command selections to processing unit 402. Other input devices may include a microphone, joystick, game pad, scanner, or the like. Also coupled to processing unit 402 through bus 401 is an input/output interface (not shown) which can be used to control and transfer data to electronic devices (printers, other computers, etc.) connected to computer system 400. Computer system 400 includes network devices 408 for connecting computer system 400 to one or more remote devices (e.g., the receiving node) 412 via network 414. Remote device 412 may be another personal computer, a server, a router, a network PC, a wireless device or other common network node and typically includes one or more of the elements described above with respect to computer system 400. Network devices 408, may include a network interface for computer system 400, Ethernet devices, network adapters, phone jacks, modems, and satellite links. It will be apparent to one of ordinary skill in the art that other network devices may also be utilized.

Thus, a method and apparatus have been disclosed for generating a controlled copy of information stored on an optical storage media. While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A method for generating a controlled copy of information stored on a source optical storage media comprising:
reading accessible information from the source optical storage media;
generating information corresponding to inaccessible information stored on the source optical storage media; and
saving the accessible information and the generated information such that the generated information is accessible.

2. The method of claim 1 wherein saving the accessible information and the generated information such that the generated information is accessible comprises saving the accessible information and the generated information on a persistent data storage media.

3. The method of claim 1 wherein saving the accessible information and the generated information such that the generated information is accessible comprises saving the accessible information and the generated information on a temporary memory.

4. The method of claim 1 wherein reading accessible information from the source optical storage media comprises:
reading user data from the source optical storage media;
determining whether channel information in a user data area is accessible on the source optical storage media; and
reading the channel information in the user data area if the channel information in the user data area is accessible.

5. The method of claim 1 wherein generating information corresponding to inaccessible information stored on the source optical storage media comprises:
generating information representative of the table of contents from the source optical storage media;
determining whether channel information in a user data area is accessible on the source optical storage media;
generating the channel information of the user data area if the channel information in the user data area is not accessible;
generating channel information of first logical lead-in area;
generating channel information of the last logical lead-out area;
generating information comprising a first logical lead-in area; and
generating information comprising a last logical lead-out area.

6. The method of claim 1 further comprising writing the accessible information and the generated information to a first optical storage media.

7. The method of claim 1 further comprising modifying the information saved to, any one of, violate optical media standards, and not violate optical media standards and writing the modified information to a second optical storage media.

8. The method of claim 7 wherein writing the modified information to a second optical storage media comprises writing a bit by bit representation of at least the modified information to the second optical storage media.

9. The method of claim 8 wherein writing the modified information to a second optical storage media comprises writing the modified information to a second optical media disc.

10. The method of claim 7 further comprising saving the modified information.

11. The method of claim 7 wherein modifying the information saved to, any one of, violate optical media standards, and not violate optical media standards and writing the modified information to a second optical storage media comprises modifying one or more bits of at least one of, the accessible information and the generated information.

12. The method of claim 2 wherein saving the at least one of the accessible information and the generated information on a persistent data storage media comprises saving the accessible information and the generated information on at least one of a floppy disk, a magnetic disk, an optical media storage disc, a magneto-optical disk, and a streaming tape.

13. A machine readable memory storing a program executable by a processor for producing a user interface, the user interface comprising:
a first display area for displaying user data for a first optical storage media;
a second display area for displaying information comprising a first logical lead-in area for the first optical storage media;
a third display area for displaying information comprising a last logical lead-out area for the first optical storage media;
a fourth display area for displaying channel information in the first logical lead-in area of the first optical storage media;
a fifth display area for displaying channel information in the user data area for the first optical storage media;
a sixth display area for displaying channel information in the last logical lead-out area for the first optical storage media;
an executable process to modify at least one of the user data, the first logical lead-in information, the last logical lead-out information, channel information in the first logical lead-in area, channel information in the user data area, channel information in the last logical lead-out area and to write at least the modified information to a second optical storage media.

14. The user interface of claim 13 further comprising the executable process to save at least the modified information to a persistent data storage media.

15. The user interface of claim 13 wherein the first optical media comprises a first optical media disc and the second optical media comprises a second optical media disc.

16. The user interface of claim 13 wherein the executable process to modify at least one of the user data, the first logical lead-in information, the last logical lead-out information, channel information in the first logical lead-in area, channel information in the user data area, channel information in the last logical lead-out area and to write at least the modified information to a second optical storage media comprises the executable process to modify the information to any one of violate optical media standards and not violate optical media standards.

17. An apparatus to generating a controlled copy of information stored on a source optical storage media comprising:
a memory; and
a processor coupled to the memory said processor to read accessible information from the source optical storage media;
generate information corresponding to inaccessible information stored on the source optical storage media; and
save the accessible information and the generated information such that the generated information is accessible.

18. The apparatus of claim 17 wherein the processor to save the accessible information and the generated information such that the generated information is accessible comprises the processor to save the at least one of the accessible information and the generated information on a persistent data storage media.

19. The apparatus of claim 17 wherein the processor to save the accessible information and the generated information such that the generated information is accessible comprises the processor to save the at least one of the accessible information and the generated information on a temporary memory.

20. The apparatus of claim 17 wherein the processor to read accessible information from the source optical storage media comprises the processor to:
read user data from the source optical storage media;
determine whether channel information in a user data area is accessible on the source optical storage media; and
read the channel information in the user data area if the channel information in the user data area is accessible.

21. The apparatus of claim 17 wherein the processor to generate information corresponding to inaccessible information stored on the source optical storage media comprises the processor to:
generate information representative of the table of contents from the source optical storage media;
determine whether channel information in a user data area is accessible on the source optical storage media;
generate the channel information of the user data area if the channel information in the user data area is not accessible;
generate channel information of first logical lead-in area;
generate channel information of the last logical lead-out area;
generate information comprising a first logical lead-in area; and
generate information comprising a last logical lead-out area.

22. The apparatus of claim 17 further comprising the processor to write the accessible information and the generated information to a first optical storage media.

23. The apparatus of claim 17 further comprising the processor to modify the information saved to, any one of, violate optical media standards and not violate optical media standards and to write the modified information to a second optical storage media.

24. The apparatus of claim 23 wherein the processor to write the modified information to a second optical storage media comprises the processor to write a bit by bit representation of at least the modified information to the second optical storage media.

25. The apparatus of claim 24 wherein the processor to write the modified information to a second optical storage media comprises the processor to write the modified information to a second optical media disc.

26. The apparatus of claim 23 further comprising the processor to save the modified information.

27. The apparatus of claim 23 wherein the processor to modify the information saved to, any one of, violate optical media standards and not violate optical media standards and the processor to write the modified information to a second optical storage media comprises the processor to modify one or more bits of at least one of, the accessible information and the generated information.

28. An article of manufacture to generate a controlled copy of information stored on a source optical storage media comprising:
a machine-accessible medium including instructions that, when executed by a machine, causes the machine to perform operations comprising
reading accessible information from the source optical storage media;
generating information corresponding to inaccessible information stored on the source optical storage media; and
saving the accessible information and the generated information such that the generated information is accessible.

29. The article of manufacture of claim 28 wherein said instructions for saving the accessible information and the generated information such that the generated information is accessible comprises further instructions for saving the accessible information and the generated information on a persistent data storage media.

30. The article of manufacture of claim 28 wherein said instructions for saving the accessible information and the generated information such that the generated information is accessible comprises further instructions for saving the accessible information and the generated information on a temporary memory.

31. The article of manufacture of claim 28, wherein said instructions for reading accessible information from the source optical storage media include further instructions for
reading user data from the source optical storage media;
determining whether channel information in a user data area is accessible on the source optical storage media; and
reading the channel information in the user data area if the channel information in the user data area is accessible.

32. The article of manufacture of claim 28 said instructions for generating information corresponding to inaccessible information stored on the source optical storage media comprises further instructions for
generating information representative of the table of contents from the source optical storage media;
determining whether channel information in a user data area is accessible on the source optical storage media;
generating the channel information of the user data area if the channel information in the user data area is not accessible;
generating channel information of first logical lead-in area;
generating channel information of the last logical lead-out area;
generating information comprising a first logical lead-in area; and
generating information comprising a last logical lead-out area.

33. The article of manufacture of claim 28 comprising further instructions for writing the accessible information and the generated information to a first optical storage media.

34. The article of manufacture of claim 28 comprising further instructions for modifying the information saved to any one of, violate optical media standards, and not violate optical media standards and writing the modified information to a second optical storage media.

35. The article of manufacture of claim 34 wherein said instructions for writing the modified information to a second optical storage media comprises further instructions for writing a bit by bit representation of at least the modified information to the second optical storage media.

36. The article of manufacture of claim 34 wherein said instructions for writing the modified information to a second optical storage media comprises further instructions for writing the modified information to a second optical media disc.

37. The article of manufacture of claim 34 comprising further instructions for saving the modified information.

38. The article of manufacture of claim 34 wherein said instructions for modifying the information saved to any one of, violate optical media standards, and not violate optical media standards and writing the modified information to a second optical storage media comprises further instructions for modifying one or more bits of at least one of, the accessible information and the generated information.

39. An apparatus to generate a controlled copy of information stored on a source optical storage media comprising:
an optical storage media input/output (I/O) interface module to read accessible information from the source optical storage media;
a dissector module coupled to the optical storage media I/O interface module to generate information corresponding to inaccessible information stored on the source optical storage media; and
a database module coupled to the dissector module to store the accessible information and the generated information such that the generated information is accessible.

40. The apparatus of claim 39 wherein the database module comprises any one of a temporary memory and a persistent data storage media.

41. The apparatus of claim 39 wherein the optical storage media input/output (I/O) interface module to read accessible information from the source optical storage media comprises the optical storage media I/O interface module to
read user data from the source optical storage media;
determine whether channel information in a user data area is accessible on the source optical storage media; and
read the channel information in the user data area if the channel information in the user data area is accessible.

42. The apparatus of claim 39 wherein the dissector module to generate information corresponding to inaccessible information stored on the source optical storage media comprises the dissector module to generate information representative of the table of contents from the source optical storage media;
determine whether channel information in a user data area is accessible on the source optical storage media;
generate the channel information of the user data area if the channel information in the user data area is not accessible;
generate channel information of first logical lead-in area;
generate channel information of the last logical lead-out area;
generate information comprising a first logical lead-in area; and
generate information comprising a last logical lead-out area.

43. The apparatus of claim 41 further comprising the optical storage media input/output (I/O) interface module to write the accessible information and the generated information to a first optical storage media.

44. The apparatus of claim 39 further comprising the dissector module to modify the information saved to, any one of, violate optical media standards and not violate optical media standards and the optical storage media input/output (I/O) interface module to write the modified information to a second optical storage media.
